(19) United States
(12) Patent Application Publication
(10) Pub. No.: US 2011/0161218 A1
(43) Pub. Date: Jun. 30, 2011

(54) CREDIT REPORTING INTERFACE

(75) Inventor: James P. SWIFT, Boca Raton, FL (US)

(73) Assignee: Cortera, Inc., Quincy, MA (US)

(21) Appl. No.: 12/888,138

(22) Filed: Sep. 22, 2010

Related U.S. Application Data
(60) Provisional application No. 61/244,732, filed on Sep. 22, 2009.

(51) Int. Cl. G06Q 40/00

(52) U.S. Cl. 705/35; 705/1.1

(57) ABSTRACT

A system and method for providing, in real time via the Internet, the exchange of credit information pertaining to assessing credit worthiness of a business. The exchange is an electronic inquiry, delivery, or reporting of credit information from individuals or companies to be accessed via Internet by a user community. In a preferred embodiment, the system includes a web site that, by using a web browser, allows clients to assess credit worthiness by accessing credit information in real time from a business, or provide credit data about a business by entering credit data in a web browser-supported format. The data is encrypted using means for secure transmission, such as a web browser, and then sent to at least one web application executed by web server software. The web server software coordinates and displays the credit data and allows for easy access by the user community, through a web browser, and displayed in an easily read format.

### CROSS REFERENCE TO RELATED APPLICATIONS

The present patent application claims priority to U.S. provisional patent application No. 61/244,732 filed on Sep. 22, 2009, which is incorporated herein by reference in its entirety.

### BACKGROUND OF THE INVENTION

This invention relates to computerized information management and processing systems generally, and more particularly to a computer-implemented system and method for assessing credit worthiness of a business by sending, displaying, retrieving, accepting and delivering credit information in real time via the Internet.

Assessing credit worthiness for businesses, particularly smaller businesses, is extremely difficult to do. For example, specific forms must be filled out in particular format, off line and then submitted to a reporting company. Then a company like Dun and Bradstreet will receive these forms filled with credit data and offer users information regarding credit worthiness of businesses. However, Dun and Bradstreet primarily deals with publicly held large businesses and also does not operate in a real time format. Furthermore, Dun and Bradstreet does not accept direct account receivable data or community user ratings in real time via the Internet, especially from smaller businesses or individuals. By the time Dun and Bradstreet assimilates the credit information for viewing by a client, it is usually weeks old because it is not done in a real time format.

But such reports, available from a handful of content providers, often prove cost prohibitive for many small businesses. In addition, the majority of credit bureaus base their credit ratings on a handful of a company's financial transactions—typically payment experiences with only the largest of suppliers and businesses—ignoring millions of interactions with small businesses that could provide a more holistic view of a business' payment behavior.

Small businesses are the lifeblood of the nation's economy, representing tens of millions of companies and 99 percent of all US businesses. Yet their payment behavior—the very action that determines credit viability and yields favorable payment terms—remains virtually invisible to potential business partners. This lack of transparency, combined with steep costs, too often leaves small businesses more vulnerable to risk than their larger counterparts and less attractive to potential business partners.

Until now, relatively few companies have provided the information that the entire business credit industry relies upon. Less than 10,000 companies contribute payment information to credit bureaus. Therefore, millions of business interaction experiences are not captured because of the old model

Various embodiments of the present invention serve to expand collection of experiences; generate unique content; and create a “sticky” environment that users can access for real time credit reports.

The current approaches for request and delivery of credit inquiries have, but are not necessarily limited to, the following problems and drawbacks. First, current credit inquiry systems may require users to maintain proprietary software on their computers, which could be costly. Second, the current system does not allow for real time credit submission and analysis via the Internet, therefore allowing millions of new sources of credit information that are currently not tapped into. In addition, responses delivered to subscribers using the credit bureau's format may be difficult to read and understand. Finally, current systems often do not enable businesses of all sizes, especially private businesses, to assess credit report data for other private businesses and also to submit their own credit report data for a potential business partner's analysis.

### BRIEF SUMMARY OF THE INVENTION

The present invention provides for a real time Internet based system and method for the exchange of credit information to and from small businesses, delivering responses to credit inquiries from users, and reporting on credit information by businesses to other users within the community, which eliminates the drawbacks of the currently employed methods of credit inquiry and reporting.

The present invention provides a user-server solution for electronic inquiry, delivery, and reporting of personal credit information to and for businesses using either serial communications and dial-up access, or the Internet and Transmission Control Protocol/Internet Protocol (TCP/IP). In a first embodiment, the present invention uses the Internet as a communications link between the user and the system, such as a web server software that functions as an credit information repository between various users or businesses.

To access the system of the present invention, the user has the following: (1) access to the Internet, such as a personal computer with Internet connection; (2) means for secure transmission over the Internet, such as a web browser; and (3) an account set up on the web server software. In addition, the system may also include encryption keys or algorithms, allowing the entities exchanging data to authenticate each other over a secured network.

The client uses a web browser on the client's computer or terminal to access the web site that is hosted on the service provider's web server software of the present invention. First, the client logs on to the system using a user name and password. Then the client enters data (e.g., customer name, address, or social security number) on an Inquiry Form generated by the web server software. The data, which is in the web browser-supported format, is passed to at least one web application executing by the web server software. The at least one web application is a specification that defines communications between information servers and resources on the server's host computer.

After the web server software receives an input command from the user, the at least one web application creates an output file containing the response to the user's inquiry. The present invention may also perform analysis or other manipulation of credit data received from a user or requested by another user. The at least one web application then sends the web browser-supported formatted data back to the user's web browser using the Internet, where the inquiry response is displayed in the user's web browser.

The primary objectives of the present invention relate to a real time system and method for receiving requests for credit information as well as receiving credit information itself from users in a web browser-supported format and sending responses back to clients in a web browser-supported format. The present invention provides a standard interface that is transparent to clients—clients do not have to interpret inquiry responses in various formats from different entities or enter data in various formats on different computer screens. Thus, a more specific object of the invention is to provide a fully automated, computer-based system for electronically inquiring, delivering, and reporting credit information in real time using a standard web browser and the Internet.

From the foregoing, it will be apparent to the reader that another object of the present invention is to provide a novel, improved system and method for requesting and supplying credit reporting information and delivering said information to users in an easily understood format in shorter periods of time than is possible using current credit inquiry techniques. Thus, the present invention becomes a more valuable tool in providing the credit information necessary for making credit-related decisions.

### BRIEF DESCRIPTION OF THE DRAWINGS

FIG. 1 is a block diagram of a system for users and businesses to make credit inquiries or credit data submissions and the system of the present invention to deliver credit inquiry responses to clients;

FIG. 2 is an example of a screen seen by a user or business at a computer or terminal when a particular inquiry is made or after submission of credit reporting data, regarding a particular business;

FIG. 3 is another example of a screen seen by a user or business at a computer or terminal when a particular inquiry is made or after submission of credit reporting data, regarding a particular business;

FIG. 4 is an example of a screen seen by a user or business at a computer or terminal when a particular inquiry is made or after submission of credit reporting data, regarding how the community rates said business;

FIG. 5 is another example of a screen seen by a user or business at a computer or terminal when a particular inquiry is made or after submission of credit reporting data, regarding how the community rates said business;

FIG. 6 is an example of a screen seen by a user or business at a computer or terminal when a particular inquiry is made or after submission of credit reporting data, regarding how the community rates specific credit details of said business;

FIG. 7 is an example of a screen seen by a user or business at a computer or terminal, regarding how a user would rate a business; and

FIG. 8 is another example of a screen seen by a user or business at a computer or terminal, regarding how a user would rate a business.

### DETAILED DESCRIPTION OF THE INVENTION

The invention summarized above and defined by the enumerated claims may be better understood by referring to the following detailed description, which should be read in conjunction with the accompanying drawings. This detailed description of a particular preferred embodiment, set out below to enable one to build and use one particular implementation of the invention, is not intended to limit the enumerated claims, but to serve as a particular example thereof. The particular example set out below is the preferred specific implementation of the present invention. Those skilled in the art should appreciate that they may readily use the concepts and specific embodiment disclosed as a basis for modifying or designing other methods and systems for carrying out the same purposes of the present invention. Those skilled in the art should also realize that such equivalent assemblies do not depart from the spirit and scope of the invention in its broadest form.

The present invention relates to a method and system for evaluating creditworthiness in real time via the World Wide Web. According to one embodiment, the method and system produce, among other things, real time qualitative and quantitative data which can be used to decide whether and to what degree to extend credit to a business. For example, the present invention may be used to decide whether to authorize a particular credit transaction, whether to approve or change an account holder's credit limit, or what terms to offer in reissuing an account. The decision may be derived from data relating to the creditworthiness of a particular company, which data may be maintained by one or more users.

In one aspect, the present invention pertains to a system for providing real-time electronic inquiry and delivery of credit information to any remote user having appropriate computer and Internet access software. In a second aspect, the present invention pertains to a method of using the Internet a web site for accepting user requests for credit information in a web browser-supported format, acquiring the credit information directly from businesses and individuals and by displaying the submitted credit information in an easy to read format that will assist the user in assessing the credit worthiness of a particular business or individual.

An element of the present invention provides insight into the overall payment behavior of the company. Each month, thousands of companies report over $200 billion of receivables data on millions of businesses. The present invention provides a score that summarizes how fast the company pays their bills.

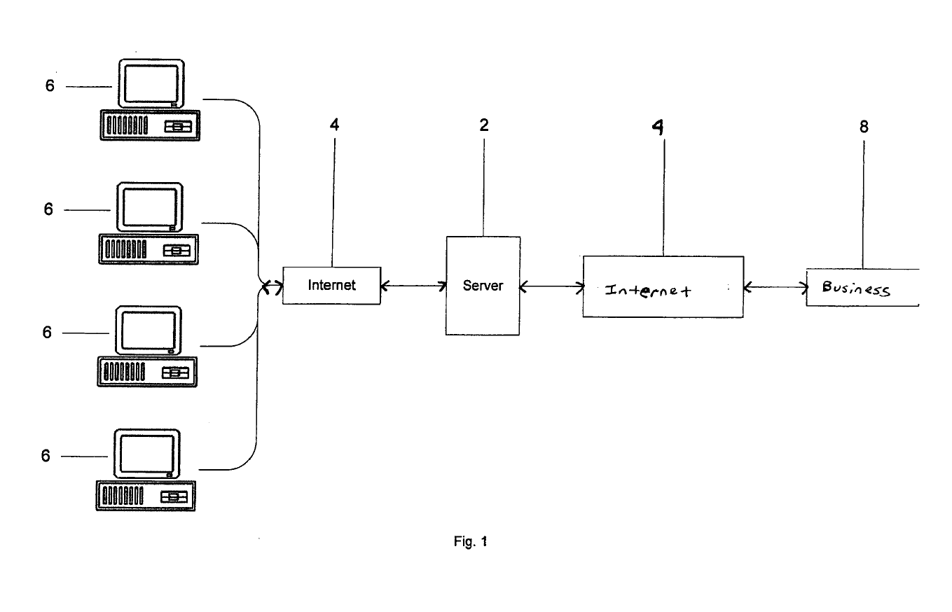

FIG. 1 depicts a system that embodies the principles of the present invention. The invention generally comprises an automated real time credit information submission, inquiry, delivery, and reporting system as shown. The major components of the system include a service provider's computer hardware running a web server software (also referred to as the “Cortera server”) 2 and a communication network 4 for connecting the web server software 2 to users' personal or other computers or terminals 6 and to connect to a business' computer or terminals 8.

The web server software 2 functions as a centralized conduit for the collection and transmission of data between the user/client 6 and the businesses 8. The web server software 2 passes the results directly to the user 6. Any number of clients 6 can access the web server software 2 to make inquiries for credit information or provide credit data to the server 2. The web server software 2 can be any mainframe, super-mini, or minicomputer system having the capability of handling a real-time, multi-tasking, remote-access database application. Any number of businesses 8 can also access the web server software 2 to make inquiries for credit information or provide credit data to the server 2.

The web server 2 processes embody the functions described herein. However, it should be apparent that there could be many different ways of implementing the invention in computer programming, and the invention should not be construed as limited to any one set of computer program instructions. Further, a skilled programmer would be able to write such computer programs to implement the disclosed invention without difficulty based on the flow charts and associated description. Therefore, disclosure of a particular set of program code is not considered necessary for an adequate understanding of how to make and use the invention.

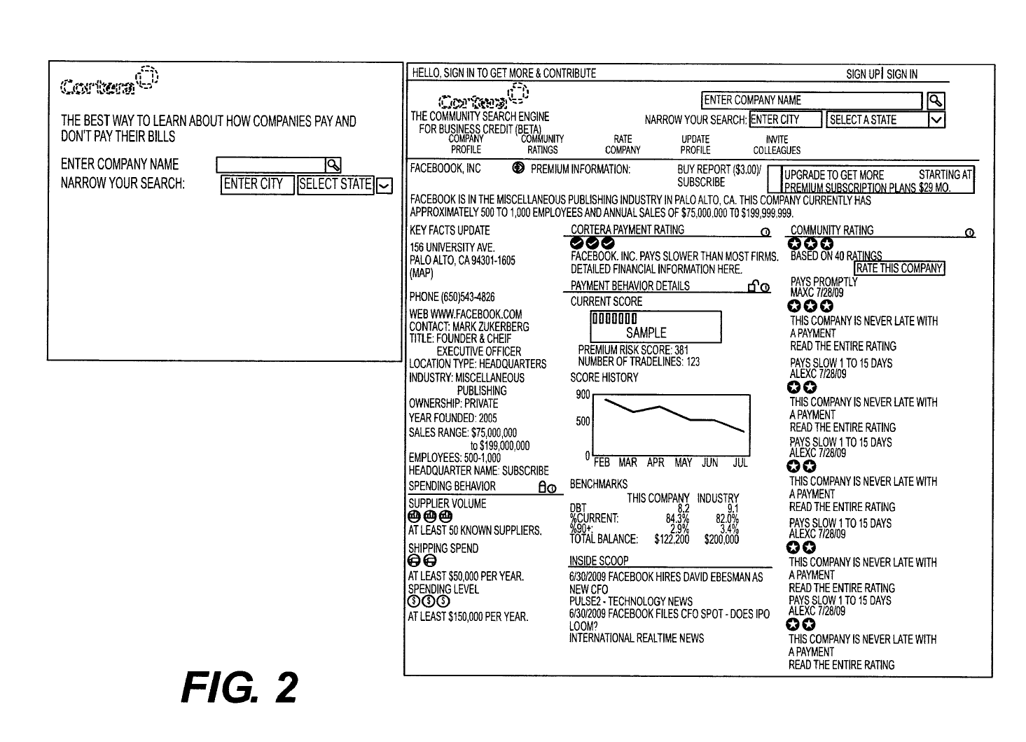

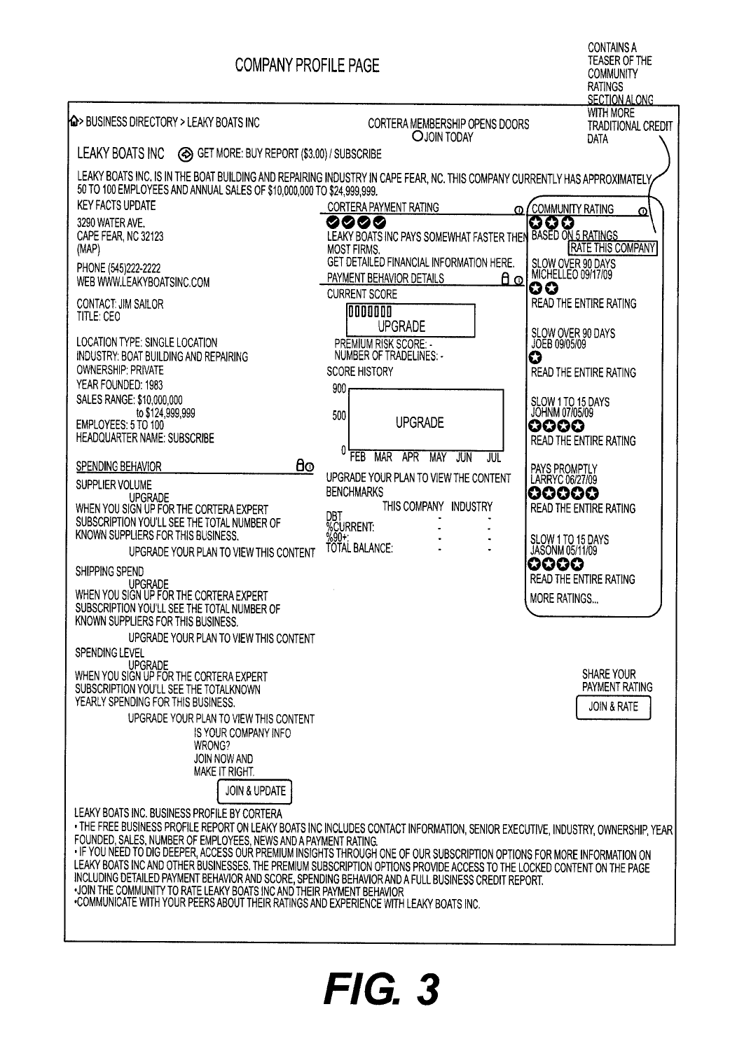

FIGS. 2 and 3 depict an example of summary screens seen by a user or a business when evaluating credit history of clients, suppliers, and partners. The present invention is designed to harnesses the power of the small business community's collective payment experiences, fundamentally shifting the way business credit is evaluated and providing greater visibility into a company's financial interactions. The present invention pulls both submitted and available data together to provide a foundation for a specific credit report. It then complements this baseline credit information with the same types of ratings and reviews features that people have embraced on popular retail, travel, and dining sites, all focused on helping credit professionals to easily share their payment experiences while learning from the experiences of others.

As seen in FIGS. 2-3, the present invention's unique features include, but are not limited to: the ability to review and rate a specific business using the popular 5-star scoring methods found on many community websites; the ability to write personal payment experience reviews and commentary; the ability to report payment history information including total balance, high balance, amount past due, days beyond terms and other key metrics; the ability to contact specific reviewers for further follow-up and peer-to-peer reference; and/or a distribution of ratings by industry and rating type.

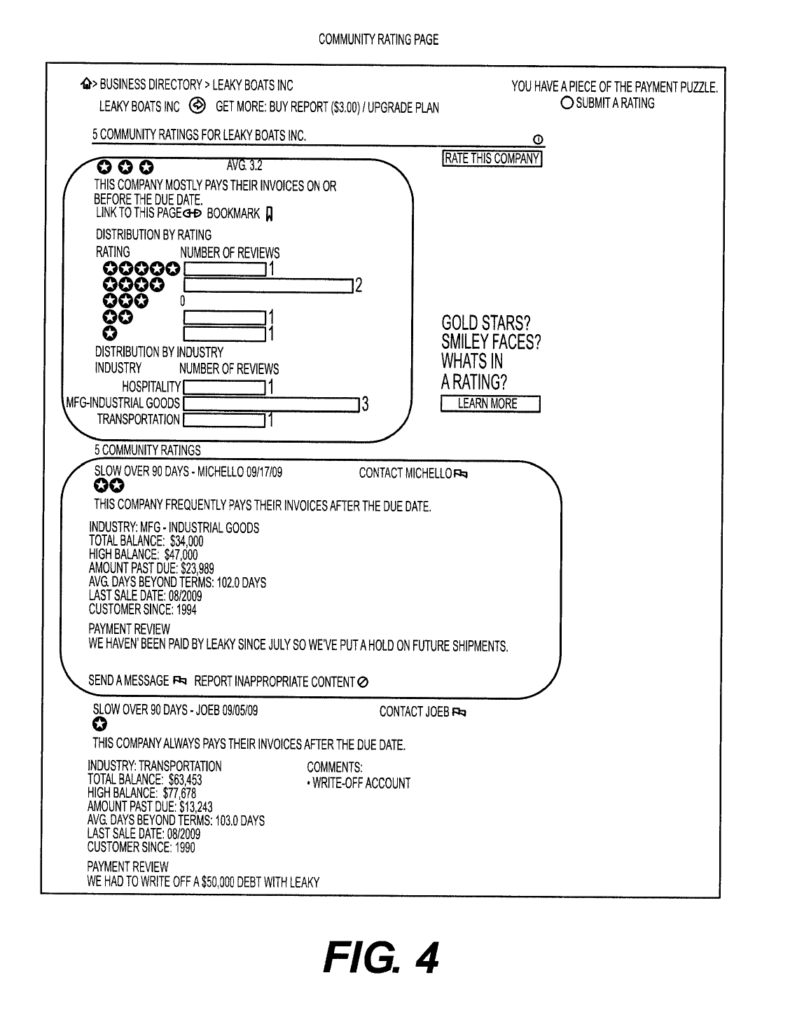

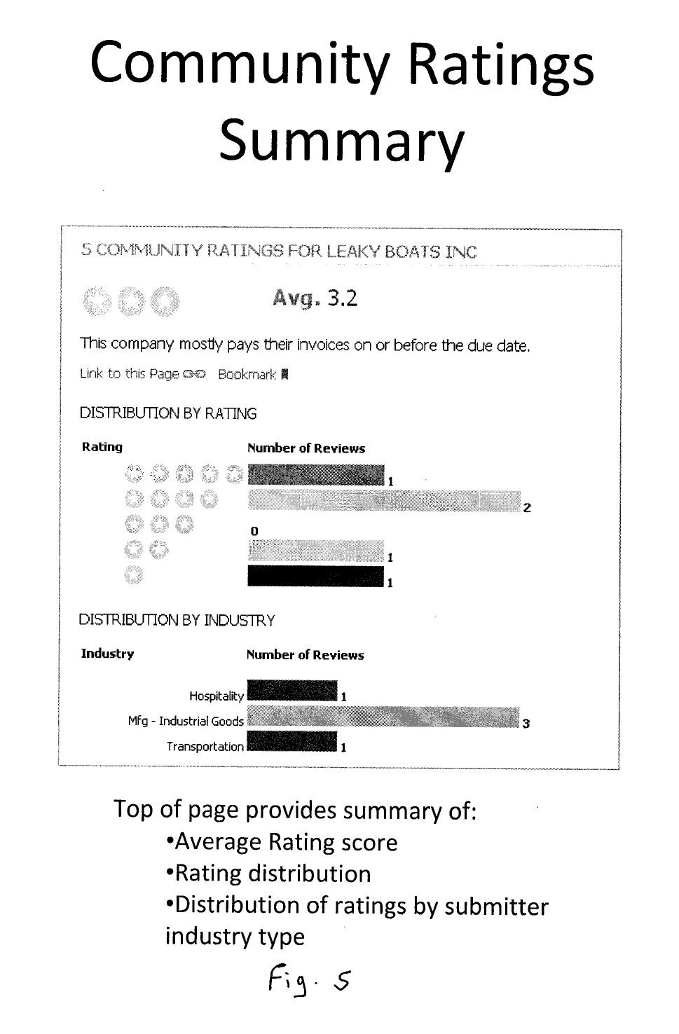

FIGS. 4 and 5 depict a screen sample that might be seen by a user or business when reviewing the credit worthiness of a particular business. Businesses commonly use credit information about their current or prospective business partners to make business-related decisions in relation to those business partners. The business may request the credit information from the system of the present invention. FIGS. 4 and 5 show the types of information that may be included in the community review section of the credit report. The credit information may indicate a degree of risk associated with the business partner, such as a degree of credit-worthiness of the business partner.

The business may need to make business-related decisions in relation to the same business partner on multiple occasions. On each occasion, it may be advantageous for the business to possess credit information that is as up-to-date as possible. For example, recent events in the financial history of the business partner may adjust the business partner's degree of credit-worthiness or other associated risk. Therefore, the business may request an up-to-date credit report from the credit reporting agency in order to be able to take these adjustments into consideration when making its business-related decisions.

However, re-transmitting the entire credit report on every occasion that it is needed by the business, in order to maintain the up-to-date credit information, may use resources inefficiently. For example, the financial history maintained by the credit reporting agency in relation to the business partner may not have changed since the business most recently requested the credit report for the business partner. Unfortunately, the business may not know whether its credit information is up-to-date. Thus, the business may unnecessarily make a new request for the credit report from the credit reporting agency in order to insure that the credit information is up-to-date.

Furthermore, each time the up-to-date credit report is transmitted to the business, an agent, such as a person or computer system, at the business may need to process the entirety of the credit report in order to update its credit information. Repeatedly processing the entirety of each credit report may waste labor and/or computer resources at the business.

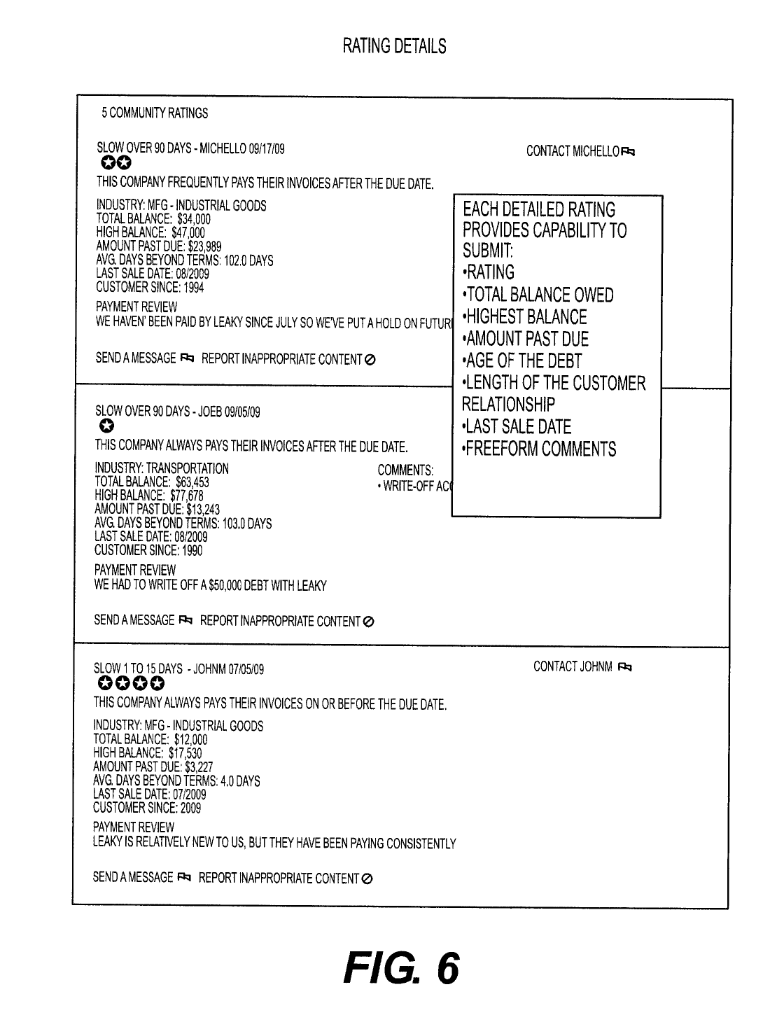

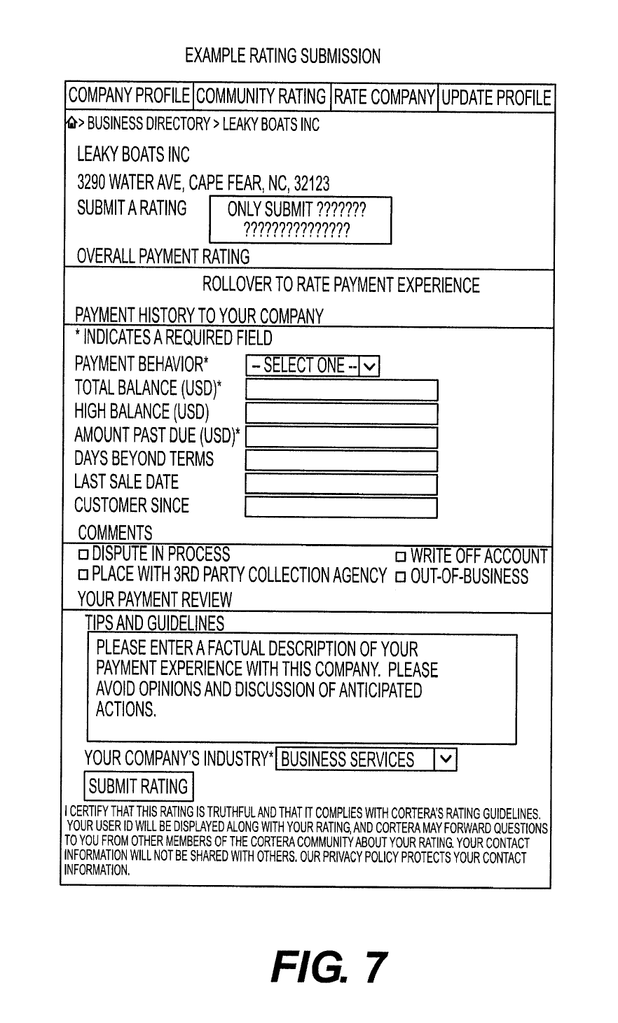

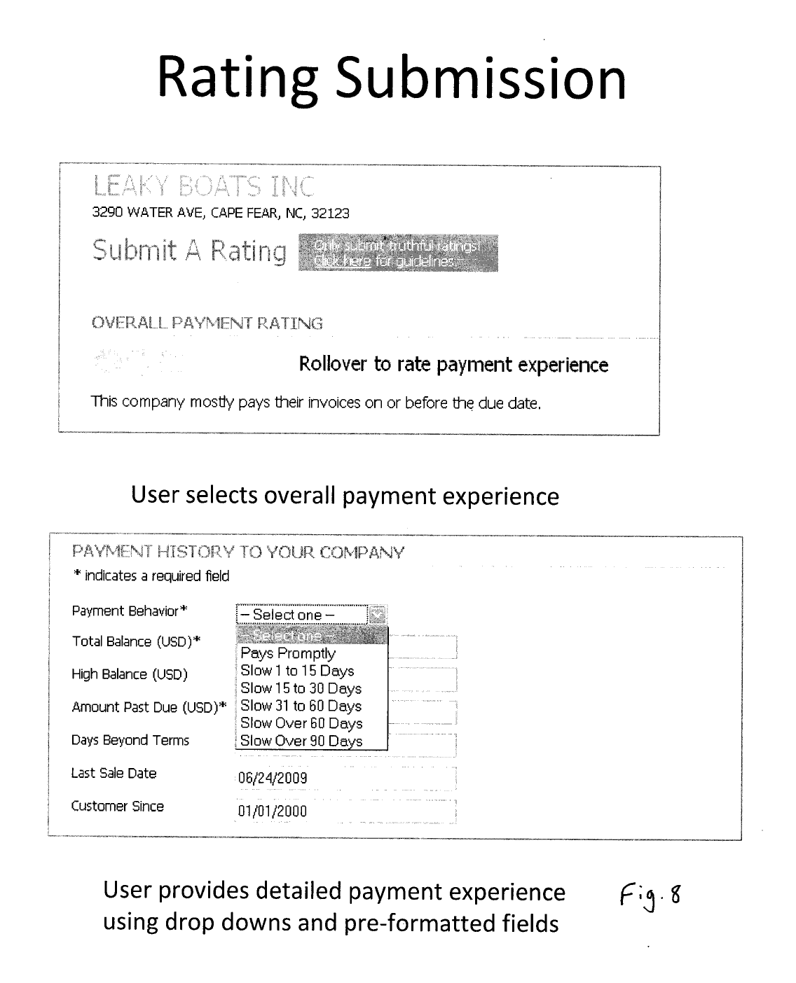

FIGS. 6-8 depict screen samples regarding how a business or user would rate a specific business's credit data. These may be referred to as rating details and allow for specific information regarding a business's credit history. Therefore, the present invention provides a method to form an opinion by unobtrusively utilizing multiple and various forms of legal and economic data in a real-time and automated manner. The rating logic and the values are uniform and applicable to all entities (e.g., individual, corporation, agency, organization, partnership, etc.), and include the use of the buyer/seller feedback to establish credibility. These entities can be individuals, legally formed corporations or organizations as well as municipalities.

In various embodiments of the present invention, the request from the entity may be a manual request. In other embodiments, the request from the entity may be an automatic request based on a predetermined event or interval of time. The credit data retrieved from sources may be classified as predictive data. The predictive data may include financial scores, credit scores, bankruptcy proceedings, judgments, liens, lawsuits, subjective feedback, business complaints, media reports and so forth.

In embodiments, the data from trusted sources may be publicly and/or commercially available data, including credit reports, financial reports, market data aggregators, electronic marketplaces, court filings, media reports, governmental records and so forth. In various embodiments, the “users” or “businesses” may be sellers, buyers, individuals, groups of people, legal entities, and/or companies. Displaying the objective opinion profile to the entity may include publishing the objective opinion profile to a list.

In general, in another aspect, the invention features a computer-implemented method of deriving an objective opinion of a buyer or customer. The method may include receiving a request for an objective opinion of the buyer or customer from a seller and retrieving data regarding the buyer or customer from trusted sources. The objective opinion profile of the buyer or customer is built from the data retrieved from the trusted sources and displayed to the seller.

The core of the system and method is a real time web based software solution that includes a graphical user interface, which both facilitates the collection and maintenance of credit data from various sources, and populates a database for assessing the credit worthiness of a business.

What is claimed is:

1. A computer-implemented method of deriving an objective credit history profile comprising:
receiving a request from a user;
retrieving data regarding the business from at least one source;
building the objective opinion profile from the data retrieved from the source; and
displaying the objective opinion profile of the business to the user in a real time format via the Internet.

2. The method of claim 1, wherein the source is an individual.

3. The method of claim 1, wherein the source is a second business.

4. The method of claim 1, wherein the data may be selected from the group consisting of: spending behavior, supplier volume, shipping data, spending level, accounts receivable data, debt collection, debt payment, industry, amount past due, amount owed and balance.

5. The method of claim 1, wherein the method further comprises real time display and submission of financial data, credit or payment history for users.

6. A method of predicting a credit worthiness of a business, the method comprising:
listing reliability characteristics including at least one business-provided reliability characteristic and at least one non-business-provided reliability characteristic;
collecting credit data about the business for a user community;
computing a business credit reliability metric predicting reliability of the merchant by applying each of the collected data values about the business as a contribution to a business reliability metric of the business; and
presenting the business reliability metric to a potential customer of the business.

7. The method of claim 6, wherein the characteristics may be selected from the group consisting of: spending behavior, supplier volume, shipping data, spending level, accounts receivable data, debt collection, debt payment, industry, amount past due, amount owed and balance.

8. The method of claim 6, wherein the method further comprises real time display and submission of financial data, credit or payment history for users.

9. A real time, internet based credit monitoring and reporting system, comprising:
a first process for accepting at least one credit rating value associated with a borrower, said at least one credit rating value being generated by at least one credit reporting user; a second process for accepting additional data pertaining to said borrower's credit status, said additional data including data not considered by said at least one credit reporting user; a third process responsive to said at least one credit rating value and said additional data to generate a custom credit rating value for said borrower.

10. The system of claim 9, wherein the value associated with the borrower may be selected from the group consisting of: spending behavior, supplier volume, shipping data, spending level, accounts receivable data, debt collection, debt payment, industry, amount past due, amount owed and balance.

11. The system of claim 9, wherein the system further comprises real time display and submission of financial data, credit or payment history for users.

12. The system of claim 9, wherein the system further comprises real time display and submission of financial data, credit or payment history for businesses.

13. The system of claim 9, wherein allowing users to ascertain or submit data or comments or feedback or advice relating to various financial services or payment history.

14. The system of claim 9, wherein the credit data is received in specific intervals of time.

15. The system of claim 9, further comprising determining, by at least one computer processor, a credit worthiness value by analyzing at least one credit reporting data.

16. The system of claim 9, wherein the user is an individual.

17. The system of claim 9, wherein the user is a business.

18. The system of claim 17, wherein the user is a small business.
